(19) United States
(12) Patent Application Publication
(10) Pub. No.: US 2008/0273797 A1
(43) Pub. Date: Nov. 6, 2008

(54) Editing System with Digital Pen, Editing Method, and Program Thereof

(76) Inventors: Toshikazu Takikawa, Tokyo (JP); Hideo Watanabe, Tokyo (JP); Riko Tanabe, Tokyo (JP); Kazuki Kureishi, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/563,150

(22) PCT Filed: Jun. 2, 2005
(86) PCT No.: PCT/JP2005/010121

§ 371 Date: Jul. 18, 2008

(30) Foreign Application Priority Data
Jun. 3, 2004 (JP) 2004-165323

(51) Int. Cl. G06K 9/00

(52) U.S. Cl. 382/188

(57) ABSTRACT

An editing system is provided which is configured to include a paper 2, which is prepared to be able to specify entry locations, and on which paper space information is printed, a digital pen 1 for acquiring information entered by hand-writing as stroke data, and a pen server 3 for editing the paper space information on the basis of the stroke data acquired by the digital pen 1, wherein the pen server 3 is configured to include a command database 309 that stores command execution information indicating a content of an editing process correspondingly to commands for specifying the editing process, extracts the paper space information on the paper, specified with the digital pen 1 and searches for command execution information corresponding to the command entered on the paper 2 with reference to the command database 309 to execute the editing process, extracts the paper space information on the paper 2 specified with the digital pen 1, searches for command execution information corresponding to the command entered on the paper 2 with reference to the command database 309, in order to execute the editing process.

### TECHNICAL FIELD

The present invention relates to an editing system and an editing method, using a digital pen and particularly to the editing system and the editing method, and its program capable of a complicated editing process for electronic files only by input with the digital pen.

### BACKGROUND ART

Conventionally, as a method for editing electronic files including characters and figures with a personal computer and the like, are generally used a method in which commands are entered with a keyboard and a method in which a GUI (Graphical User Interface) is operated with a pointing device such as a mouse.

Here, a patent document 1 discloses a method of obtaining an order content at a restaurant and the like, in which a hand-written image written by a user is associated with some of order choices in a menu by enter on the menu where a dot pattern is formed to specify an entry location with the digital pen having a readout function of the dot pattern.

In such a personal computer equipped with the digital pen as an input means as disclosed in the patent document 1, entering or editing operation of characters and figures is enabled using this digital pen without using the keyboard and the like. As the editing system of the electronic files with such the digital pen is cited a pen-input figure editing system disclosed in a patent document 2.

Patent document 1: tokuhyo 2003-500777 (paragraphs 0050-0054, 0119-0122, and FIG. 2)

Patent document 2: Japanese laid-open patent application publication 6-208654 (paragraphs 0020-0025, and FIGS. 1 and 2)

### DISCLOSURE OF THE INVENTION

However, in the pen-entry figure editing system described in the patent document 2, because an editing process for the electronic file is carried out by gestures configured with simple symbols and the like entered with the input means such as the digital pen, it is difficult to execute complicated editing processes.

Therefore, an object of the present invention is to provide means capable of performing a complicated editing process only by entry with a digital pen in an editing operation of the electronic file.

An editing system according to the present invention that has been made for the above-described object is characterized by being configured to include: a paper (2) which is prepared to be able to specify an entry location and includes paper space information such as figures and characters; a digital pen (1) that obtains information entered by hand-writing as stroke data; and a pen server (3) that edits the paper space information on the basis of the stroke data obtained by the digital pen (1), wherein the pen server (3) is configured to include a command database (309) that stores command execution information indicating a content of an editing process correspondingly to commands for specifying the editing process, and characterized in that the editing system extracts the paper space information on the paper (2) specified with the digital pen (1) to search the command database (309), and performs the editing process on the basis of the command execution information corresponding to the command entered on the paper (2).

Further, the paper (2) used in the editing system mentioned above is characterized in that the paper space information is printed, and characterized by being configured to include a specifying region (52) for specifying a region for editing the paper space information with the digital pen (1) and a command entry region (53) for entering a command with the digital pen (1).

### BRIEF DESCRIPTION OF DRAWINGS

FIG. 1 is a drawing indicating a structure of an editing system in an embodiment of the present invention.

FIG. 2 is a drawing indicating an internal structure of a digital pen of the embodiment.

FIG. 3 is a drawing indicating information stored in a command database.

FIG. 4 is a drawing explaining information stored in a paper space information database.

FIG. 5 is a drawing illustrating a paper where paper space information of a workbook for a textbook is printed and an outputted file.

FIG. 6 is a flowchart explaining a procedure of a file output by a pen server.

FIG. 7 is a flowchart indicating an execution procedure of a command of ‘SCRAP’.

FIG. 8 is a drawing illustrating the paper where paper space information of a meeting document is printed and an outputted file.

FIG. 9 is a flowchart indicating an execution procedure of a command ‘MEMO’.

FIG. 10 is a drawing illustrating information stored in a classified information database.

FIG. 11 is a drawing illustrating the paper where paper space information of an F-term providing operation and an outputted file.

FIG. 12 is a flowchart illustrating an execution procedure of a command ‘FTERM’.

FIG. 13 is a drawing illustrating the paper where the paper space information of the meeting document is printed when character information is added to the paper space information.

FIG. 14 is a flowchart illustrating an execution procedure of a command ‘REC’.

### BEST MODE FOR CARRYING OUT THE INVENTION

(Editing System)

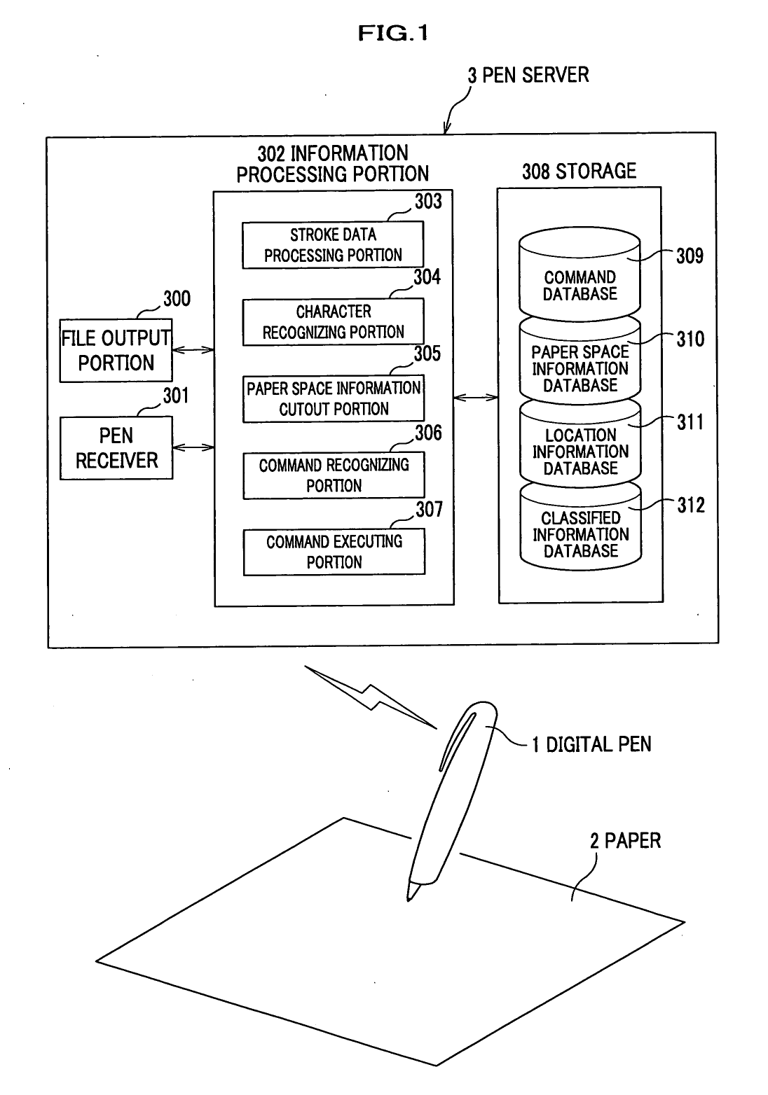

A preferred embodiment of the present invention will be described with the attached drawings. First, for example, FIG. 1 is a structural drawing of an editing system according to an embodiment of the present invention. As shown in FIG. 1, the editing system of the present embodiment is mainly configured with a digital pen 1 for obtaining stroke data which is entered on a paper 2 and transmitting it to a pen server 3, the paper 2 on which a special dot pattern so printed as to specify an entry location, and the pen server 3 which outputs an output file derived by editing the paper space information printed on the paper 2 after recognizing an entered command from the stroke data transmitted from the digital pen 1. Next, will be described respective structural elements of the editing system of the present embodiment.

(Digital Pen)

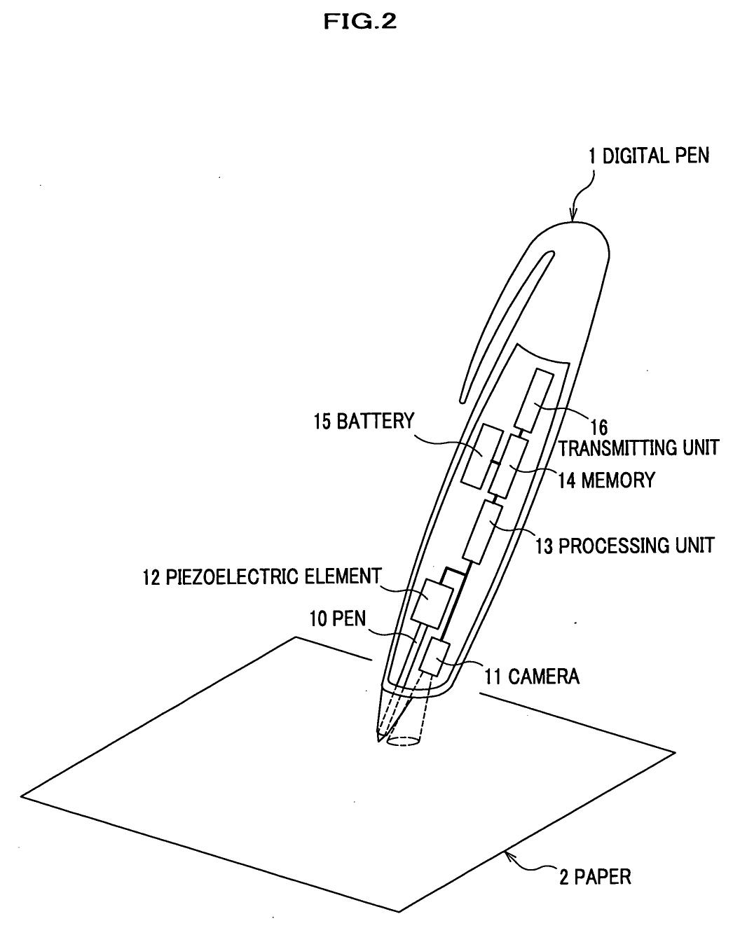

The digital pen 1 used in the present embodiment converts information entered on the paper 2 by a person of inscription into stroke data to transmit it to the pen server 3. Here, FIG. 2 shows an example of a structural drawing of the digital pen 1 used in the present embodiment. As shown in FIG. 2, the digital pen 1 comprises a pen 10 which is writing means for entering commands and the like on the paper 2 on which the special dot pattern is printed, a camera 11 for reading out the dot pattern printed on the paper 2, a piezoelectric element 12 for detecting a tool force acting on the pen 10 upon entering, a processing unit 13 for generating the stroke data that is information which relates a location of a tip of the pen 10 that moves as entering with the dot pattern, a memory 14 for accumulating the generated stroke data and the like, a battery 15 for supplying an electric power to the digital pen 1, and a transmitting unit 16 for transmitting the stroke data to the pen server 3 and the like.

As an example of this transmitting unit 16 a unit for transmitting and receiving data using a radio wave having a predetermined frequency band in accordance with a communication protocol of Bluetooth (registered trademark), which is a kind of a short distance wireless transmission technology. However, units for transmitting and receiving data in accordance with communication protocols for other wireless technologies, a wireless LAN (Local Area Network), or a wired communication may be used. Further, the processing unit 13 comprises electronic/electronic circuits such as a CPU (Central Processing Unit) and a ROM (Read Only Memory) for integrally controlling the digital pen 1. More specifically, preparation of the stroke data from the dot pattern on the paper 2 included in picture information obtained by the camera 11, a transmission of the stroke data to the pen server 3, and the like are cited.

(Paper)

The paper 2 functions as a paper for an electronic process by having a special dot pattern printed similarly to the paper described in the patent document 1. This dot pattern is provided in a case that dots are arranged such that their locations can be specified when the paper is sectioned to have a grid of a predetermined size, so that the location on the paper can be specified from the dot pattern. Further, on the paper 2 is printed the paper space information and thus the person of entry on the paper can make an entry after specifying an entry content and an entry location with viewing the paper space information.

In addition, the paper space information and its layout printed on the paper 2 of the present embodiment will be described in detail in examples of the embodiment mentioned later.

(Pen Server)

A structure of the pen server 3 will be described again with reference to FIG. 1. The pen server 3 mainly comprises a file output portion 300 for outputting the output file of the electronic file in which the paper space information such as character information and figure information printed on the paper 2, a pen receiver 301 for receiving the stroke data and the like transmitted from the digital pen 1, an information processing portion 302 for executing various information processes, and a storage 308 in which various data pieces are stored.

More specifically, the information processing portion 302 in the pen server 3 mainly comprises a stroke data processing portion 303 for converting the stroke data entered on the paper 2 transmitted from the digital pen 1 into image data, a character recognizing portion 304 for recognizing characters from image data outputted by the stroke data processing portion 303 to convert them into character codes, a paper space information cutout portion 305 for recognizing lines from the image data outputted from the stroke data processing portion 303 to extract the paper space information of which target region is specified by being underlined or circled with the lines, a command recognizing portion 306 for detecting a command stored in the command database 309 from a character code string converted by the character recognizing portion 304, and a command executing portion 307 for executing an editing process by reading command execution information mentioned later that corresponds to the command detected by the command recognizing portion 306.

Further, the pen server 3 has a communication function with the digital pen 1 and established with a general personal computer having the CPU, a RAM, a hard disk drive and the like, in which the stroke data processing portion 303 included in the information processing portion 302, the character recognizing portion 304, a paper space information cutout portion 305, the command recognizing portion 306, and the command executing portion 307 are provided by that program codes, stored in the hard disk drive of the pen server 3, for providing respective functions of the pen server 3 are loaded on the RAM and executed by the CPU.

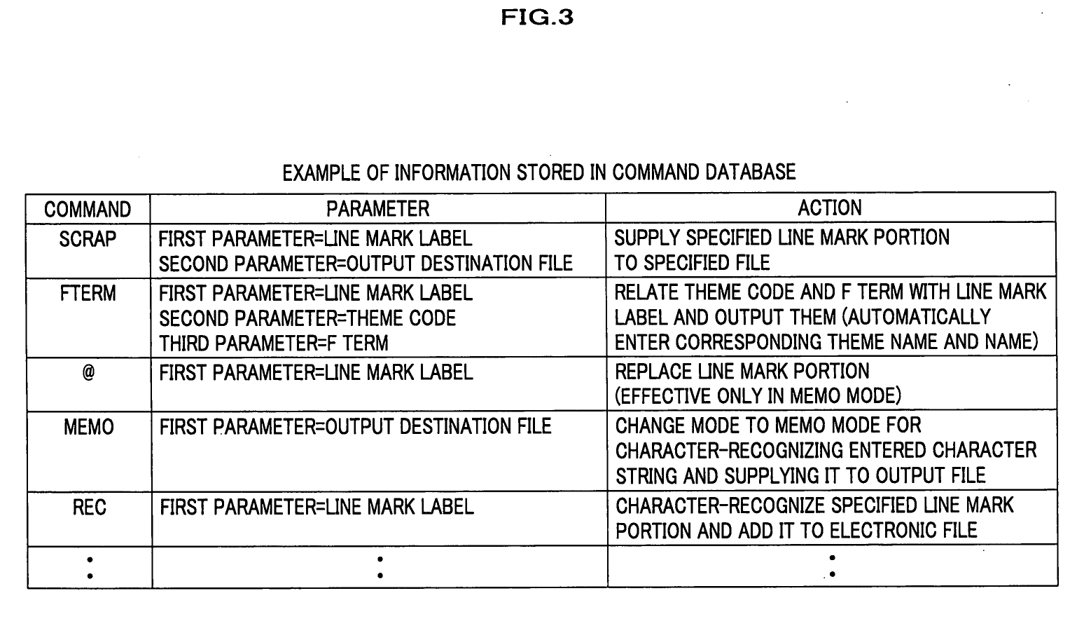

Next, will be described respective databases included in the storage 308. The command database 309 is a database in which the commands for editing the paper space information, parameter definition information for defining parameters corresponding to the commands, and command execution information indicating execution content of the commands are stored. Here, FIG. 3 indicates an example of the information stored in the command database 309. As shown in FIG. 3, in the command database 309, for each command entered to edit the paper space information, parameter definition information for defining a parameter of the command and command execution information indicating an execution content of the command are correspondingly stored. Further, in the command database 309 shown in FIG. 3, for convenience of an explanation, the command execution information is indicated as a sentence. Actually, program codes for realizing the execution content are stored, respectively.

In addition, at the paper space information database 310, for each paper 2, the dot pattern of the paper 2 and the paper space information to be printed on the paper 2 are correspondingly stored, and it includes paper space attribution information defining whether the region entered with the digital pen 1 is a region where characters are to be entered or a figure such as lines is entered. In addition, the location information database 311 is a database where the stroke data entered with the digital pen 1 on the paper 2 and the image data of the stroke data converted by the stroke data processing portion 303 are stored. Further, the classified database 312 stores a theme code used in a patent classification, and a theme name and a name corresponding to an F term.

In addition, these databases are realized by assigning regions derived by sectioning the hard disk drive of the pen server 3. Further, particularities of the information stored in the paper space information database 310 and the classified information database 312 will be described in detail in the examples of the embodiment mentioned below.

### FIRST EXAMPLE OF EMBODIMENT

### Scrap Making

Next, a first example of the embodiment will be described where a person of the entry, using the editing system of the embodiment mentioned above, prepares a scrap file by scraping a desired document with the digital pen 1 from the paper 2 where the paper space information of the workbook for the textbook is printed.

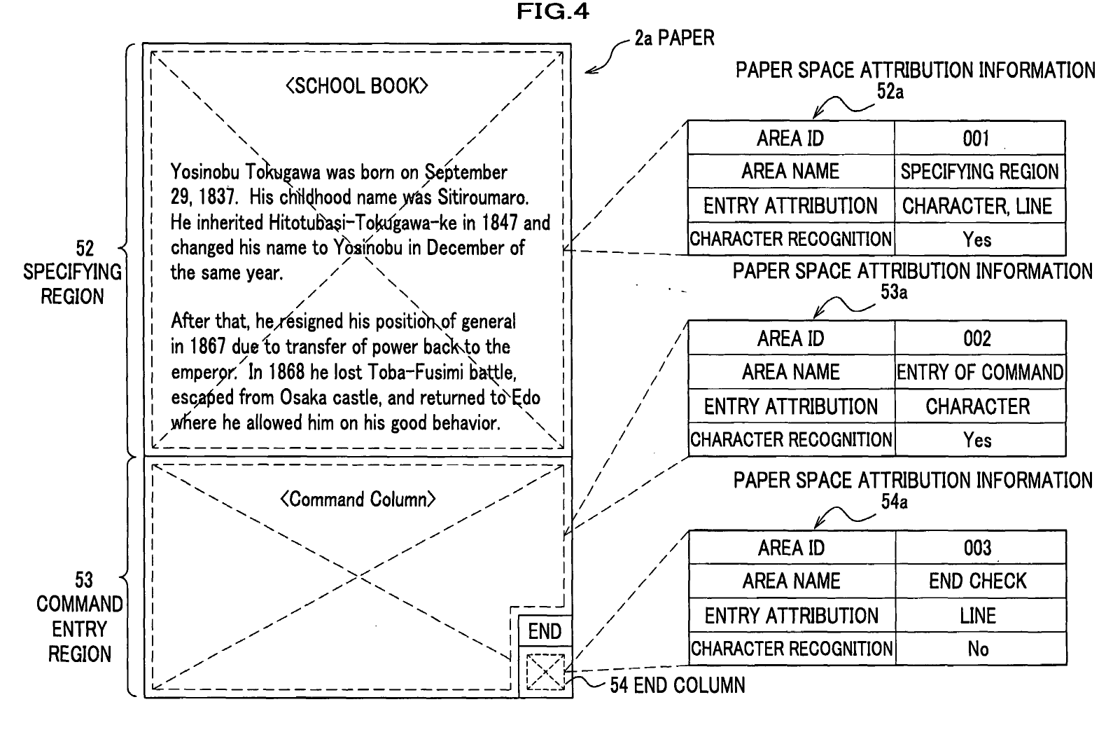

First, will be described in detail the information stored in the paper space information database 310 of the pen server 3 shown in FIG. 1. For example, FIG. 4 is a drawing illustrating the paper 2a of the first example of the embodiment and its corresponding information stored in the paper space information database 310.

As shown in FIG. 4, the paper 2a of this example of the embodiment on which the paper space information about the content of the workbook for the textbook and is configured with a specifying region 52 for specifying a region to be scrapped using the digital pen 1 with the printed paper space information viewed and a command entry region 53 that is a region on which the command for executing the editing process is entered in the pen server 3. Further, at a lower right portion of the command entry region 53 is included an end column 54 where a check is to be entered when the entry with the digital pen 1 finishes.

On the paper 2a shown in FIG. 4, regions surrounded by broken lines indicate regions where input attributions of the digital pen 1 are set, and no indication is made on the actual paper 2a. At each region surrounded by the broken lines, the paper space attribution information is previously set.

The paper space information set in each region includes items of ‘area ID’ uniquely assigned to this region, ‘area name’ for indicating a name of this region, ‘input attribution’ for indicating a kind of the information entered in this region, and ‘character recognition’ for indicating whether the information entered in this region is subject to character recognition.

For example, in the region surrounded by the chain lines of the specifying region 52 of the paper 2a because it is a region for specifying a region of making a scrap from the paper space information with the digital pen 1, at the paper space attribution information indicated by a symbol 52a, it is set that the information inputted with the digital pen 1 in this region is characters or lines and the inputted information is subject to the character recognition in the character recognition portion 304 of the pen server 3.

Similarly, in the region surrounded by the chain lines of the command entry region 53 of the paper 2a, because it is a region for entering a command for causing the pen server 3 to execute the editing process, at a region of the paper space attribution information indicated by a symbol 53a, it is set that the information inputted with the digital pen 1 in this region is characters and the inputted information is subject to the character recognition in the character recognition portion 304 of the pen server 3.

Further, in the region surrounded by chain lines of the end column 54 of the paper 2a, because it is a region for entering a check mark with the digital pen 1, at the paper space attribution information indicated by the symbol 54a, it is set that the information entered with the digital pen 1 in this area is lines and the entered information is not subject to the character recognition.

The paper space information and the paper space attribution information are stored in the paper space information database 310 with correspondence to an actual location at the paper 2a using the information of the not-shown dot pattern that can specify the location.

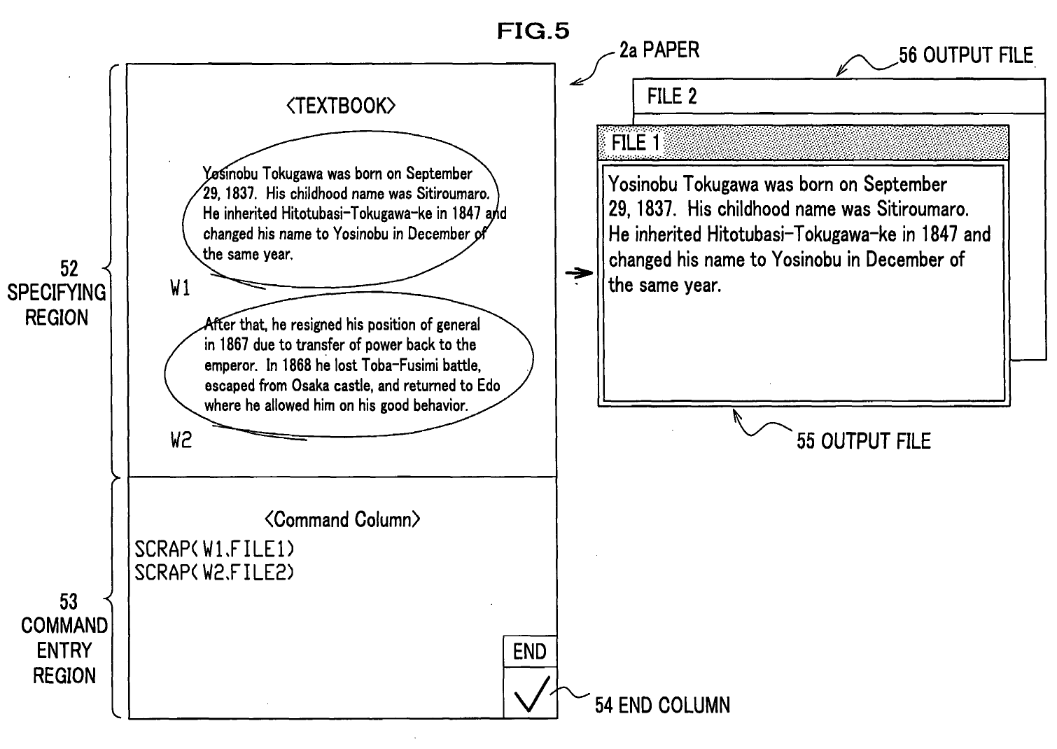

Next, FIG. 5 is a drawing indicating an example of the paper 2a in which commands and the like for editing with the digital pen 1 are entered, and output files 55 and 56 outputted after the pen server 3 edits them. On the paper 2a shown in FIG. 5, a sentence, “Yoshinobu Tokugawa is ---” is obtained by printing the paper space information stored in the paper space information database 310, wherein symbol ‘W1’ and a circled portion at its upper right portion are entered with the digital pen 1.

Further, ‘SCRAP (W1, FILE1)’ and ‘SCRAP (W2, FILE2)’ in the command entry region 53 are entered with the digital pen 1.

At this time, the person of entry enters a symbol in its vicinity after, for example, circling a region to be made a scrap from the paper space information while viewing the paper space information printed in the specifying region 52 of the paper 2a. In the example shown in FIG. 5, the region to be made a scrap is specified by circling the paper space information, and the symbols ‘W1’ and ‘W2’ are entered at their lower left portions, respectively.

In addition, in the command entry region 53, the commands for causing the pen server 3 to execute editing and parameters are entered. It is understood that in the example shown in FIG. 5, the command ‘SCRAP’ and its parameters ‘(W1, FILE1)’ and ‘(W2, FILE2)’ are entered.

The command ‘SCRAP’ means to “output a portion related to ‘W1’ toward a file of ‘FILE1’” from the command execution information stored in the command database 309 shown in FIG. 3. The pen server 3 recognizes the command and thus outputs the output files 55 and 56.

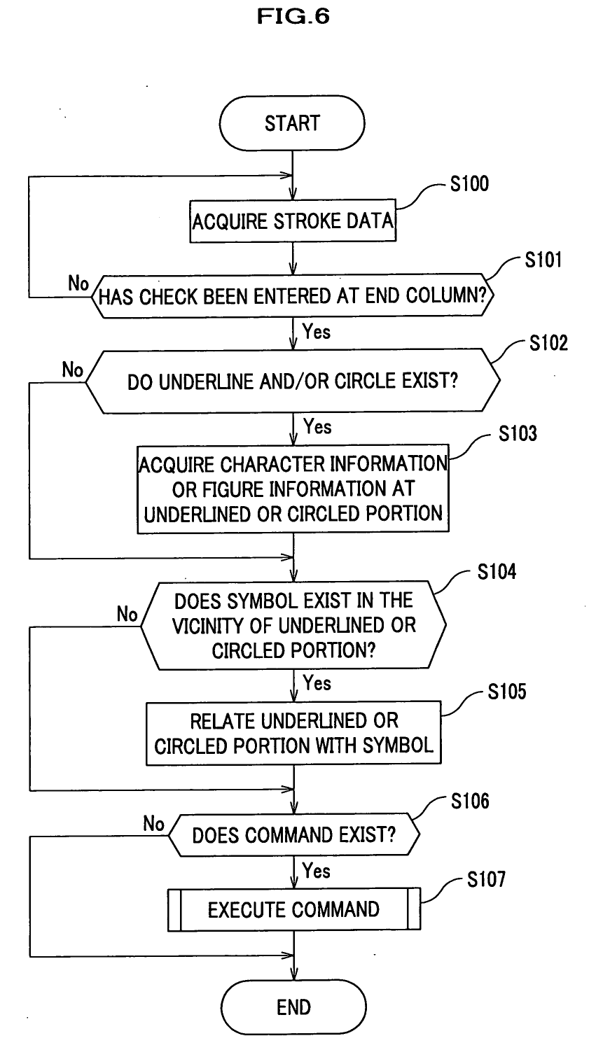

Next, FIG. 6 is a flowchart indicating a procedure of executing the editing process after acquisition of the stroke data entered on the paper 2a. With reference to the flowchart shown in FIG. 6 will be described the execution procedure of the editing process of the pen server 3 (see FIG. 1 as needed).

First, the pen server 3 receives the stroke data entered with the digital pen 1 on the above-mentioned paper 2a (step S100) from the pen receiver 301. After that, the stroke data processing portion 303 converts the stroke data into the image data, judges whether or not the person of the inscription has entered a check in the end column 54 of the paper 2a (step S101), and continues to acquire the stroke data in the step S100 until the check is entered in the check entry column.

In addition, the entered stroke data and the image data of the stroke data converted by the stroke data processing portion 303 are sequentially stored in the location information database 311 of the pen server 3.

When the check is entered in the end column 54 (Yes in the step S101), the paper space information cutout portion 305 of the pen server 3 judges whether or not the underline and/or circling exists in the specifying region 52 of the paper 2a from the image data of the stroke data entered in the specifying region 52 of the paper 2a (step S103). If the underline and/or the circle exists (Yes in step S102), character information and/or figure information of the paper space information underlined or circled is cut off for temporal acquisition (the step S103). If there is no underline and no circle (No in the step S102), processing proceeds to a next procedure, skipping the process in the step S103.

On the paper 2a shown in FIG. 5, the circled sentence is temporarily acquired as the character information. Further, if a figure and the like are circled, the figure information of the figure is temporarily acquired. Furthermore, if a region including the character information and the figure information such as a table is circled, the character information and the figure information are temporarily acquired together.

Next, the paper space information cutout portion 305 of the pen server 3 judges whether or not a symbol exists in the vicinity of the underline or circle from the image data of the stroke data entered in the specifying region 52 of the paper 2a (step S104). This judgment as to whether or not there is the symbol in the specifying region 52 can be made in a case that the symbol is a character such that the presence of the reference is judged if a predetermined character string exists after the character recognizing portion 304 converts the image data of the stroke data entered in the specifying region 52 into character codes.

Further, if the symbol is a not-shown mark, it can be considered that a predetermined pattern of codes is stored in the database in advance and the presence or the absence is judged by prior art pattern-matching.

In the step S104, when the symbol is entered in the vicinity of the underline or the circle (Yes in the step S104), the paper space information temporarily acquired in the step S103 corresponding to the underline or the circle is related with this symbol (step S105).

The procedure for judging the presence or the absence of the underline and the circle in the step S102 and the judgment as to whether or not there is the symbol in the vicinity of the underline or the circle in the step S104 are made in no particular order. Further, it can be configured to first execute the judgment of the presence or the absence of the symbols in the step S104, and not to acquire the paper space information at the underline or the circled portion where no symbol exists in the vicinity.

Next, the command recognizing portion 306 of the pen server 3 judges whether or not the command exists at the command entry region 53 (step 106) from the image data of the stroke data entered in the command entry region 53 of the paper 2a with reference to the command stored in the command database 309 (see FIG. 3). This judgment whether or not the command is entered in the command entry region 53 can be provided such that the command is judged to be entered when a predetermined character string exists after the image data of the stroke data entered in the command entry region 53 is converted into character codes at the character recognizing portion 304.

In the step S106, if the command has been entered (Yes in the step S106), the command executing portion 307 reads the command execution information in the command database 309 to execute the recognized command (step S107). If the command is not entered in the command entry region 53 (No in the step S106), the process ends as it is.

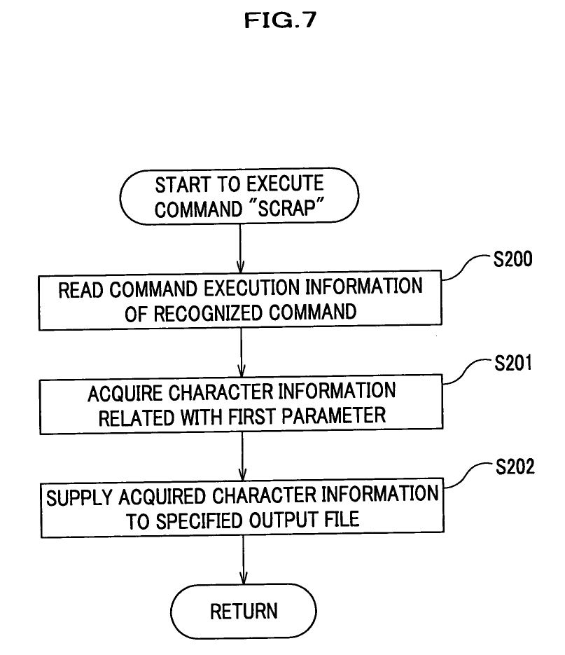

In detail will be described the execution process for commands in the step S107. FIG. 7 is a flowchart, in this example of the embodiment, illustrating a procedure of a command execution process when the command ‘SCRAP’ is recognized in the procedure in the step S106 for judging of the presence or absence of the command. With reference to FIG. 7 will be described the command execution process when two commands ‘SCRAP (W1, FILE1)’ and ‘SCRAP (W2, FILE2)’ are entered similar to the command entry region 53 of the paper 2a shown in FIG. 5 (see FIGS. 1 and 5 as needed).

First, in the step S106, when the command recognizing portion 306 of the pen server 3 recognizes the command ‘SCRAP’, the command executing portion 307 of the pen server 3 reads the command execution information of the command ‘SCRAP’ (step S200) from the command database 309 (see FIG. 3). After that, the command executing portion 307 supplies the paper space information related to the code ‘W1’ on the basis of the command ‘SCRAP (W1, FILE1)’ from the command execution information. Thus, the command executing portion 307 acquires the character information related in the step S105 to the code ‘W1’ of the first parameter (step S201).

Next, the command executing portion 307 supplies the character information acquired in the step S201 from the file output portion 300 to the output file 55 having the second parameter of ‘FILE1’ (step S202). The above-mentioned similar process is also executed for the command ‘SCRAP (W2, FILE2)’ to output the output file 56.

In addition, in this example of the embodiment, the paper space information related to the first parameter is outputted as the output file of an electronic file. However, it is also possible to execute, instead of this, to cause a not-shown display unit to make a display, to output a printed matter from printing means such as a printer, and to transmit an output file through a communication line, by entering information for specifying an output location at the second parameter.

### SECOND EXAMPLE OF EMBODIMENT

### Meeting Minutes Record Making

Next, will be described a second example of the embodiment in which minutes of a meeting are outputted as the output file after the paper space information regarding a meeting material is edited with the editing system according to the above-mentioned embodiment.

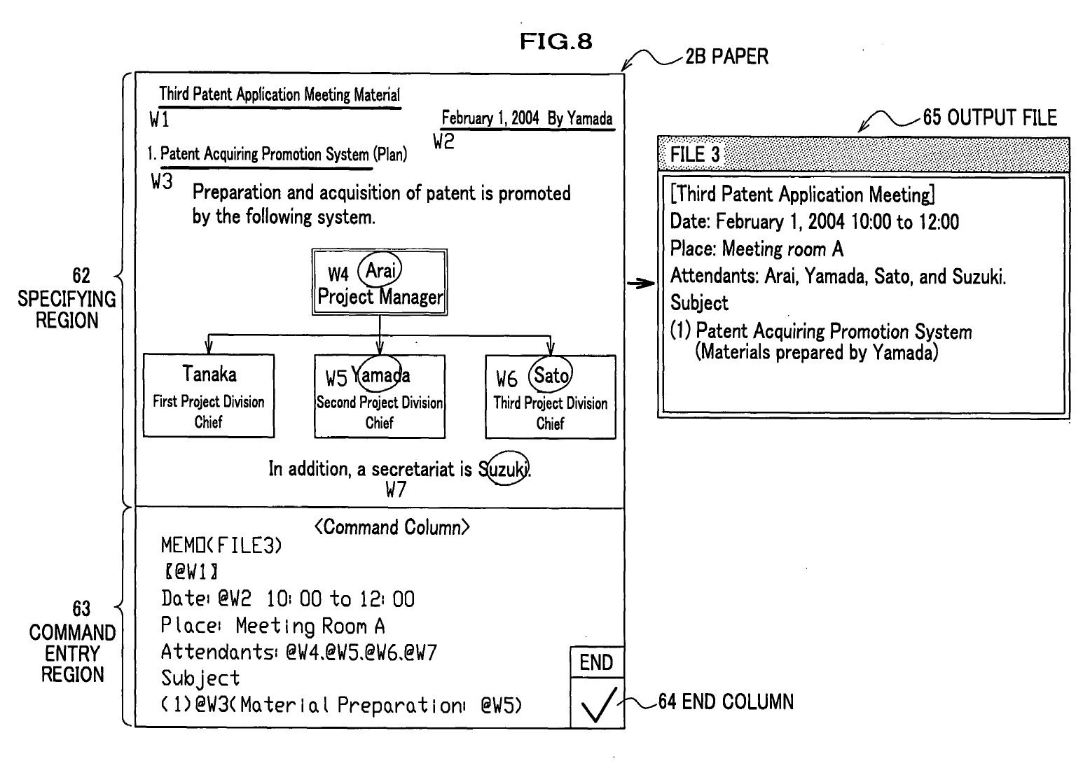

Here, FIG. 8 is a drawing showing a paper 2b of the second example of the embodiment and an output file 65 outputted after edit. As shown in FIG. 8, the paper 2b of the second example of the embodiment is subject to printing the paper space information of a content of a meeting material and configured with a specifying region 62 at which a portion desired to be cited is specified with the digital pen 1 and a command entry region 63 of a region at which the command for causing the pen server 3 to execute editing. Further, at a lower right portion of the command entry region 63 is included an end column 64 for entering the check when the entry with the digital pen is finished.

In addition, on the paper 2b, the underline or the circle in the specifying region 62 and the references entered at the left thereof are entered with the digital pen 1, and other characters are obtained by printing the paper space information stored in the paper space information database 310. Further, a description content below ‘MEMO (FILE3)’ of the command entry region 63 is entered with the digital pen 1.

The person of the inscription, for example, draws an underline at a portion that is desired to be cited from the paper space information to the minutes while viewing the paper space information printed in the specifying region 62, and enters symbols in the vicinity thereof. In the example shown in FIG. 8, the paper space information that is desired to be cited is underlined or circled, and the symbols ‘W1’ to ‘W7’ are entered at the left thereof, respectively.

In addition, in the command entry region 63 are filled the commands for causing the pen server 3 to execute editing and the parameters thereof. In the example shown in FIG. 8, it is understood that the command ‘MEMO (FILE3)’, a command ‘@’, and ‘W1’ to ‘W7’ of parameters of the commands ‘@’ are entered.

The command ‘MEMO (FILE3)’ means to “perform the character recognition of an entered character string and supply it to a file ‘FILE3’ from the command execution information in the command database 309 in FIG. 3. The command ‘@’ means to “replace the portion where the command ‘@’ is entered with the paper space information related to the parameter”, so that the pen server 3 recognizes these commands to output the output file 65.

In addition, in the second example of the embodiment, the procedure in which the pen server 3 acquires the stroke data to recognize the commands and the like entered on the paper 2b is similar to the procedure (from the step S100 to the step S105) shown in FIG. 6, and thus, the description will be omitted.

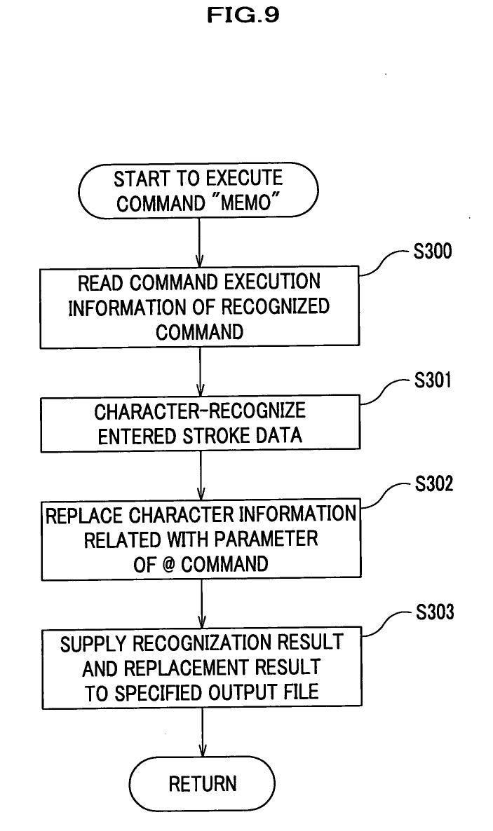

However, in the present embodiment, because the command entered in the command entry region 63 is different from the first example of the embodiment, an execution process of the commands in the step S107 will be described in detail. Here, FIG. 9 is a flowchart describing the procedure of the command execution process when the command ‘MEMO’ is recognized in the procedure for judging whether the command is present or absent in the step S106. With reference to FIG. 9, will be described the command execution process in a case that the command ‘MEMO (FILE3)’ and the commands ‘@’ and the like are entered similar to the command entry region 63 of the paper 2b shown in FIG. 8 (see FIGS. 1 and 8 as needed).

First, in the step S106, when the command recognizing portion 306 of the pen server 3 recognizes the command ‘MEMO’, the command executing portion 307 of the pen server 3 reads the command execution information of the command ‘MEMO’ (a step S300) from the command database 309 (see FIG. 3). As a result of this, the command executing portion 307, using this command execution information, performs a character recognition of the image data of the stroke data described below the command ‘MEMO’ on the basis of the command ‘MEMO (FILE3)’ to supply it to the output file ‘FILE3.’Next, the command executing portion 307 performs the character recognition of the image data of the stroke data entered after the command ‘MEMO’ and converts it into character codes (step S301). Here, if the recognized character codes include the command ‘@’, the parameter of the command ‘(’ and related character information or the figure information are replaced at the entry locations of the command ‘@’ and the parameter (step S302).

After that, the command executing portion 307 supplies the character codes subject to the character recognition in the step S301 and the character information or the figure information replaced in the step S302 from the file output portion 300 to the output file 55 indicated as ‘FILE3’ that is the first parameter of the command ‘MEMO’ (step S303).

According to the above-described procedure, the output file 65 is outputted that is the meeting minutes after the paper space information regarding the meeting material is edited.

### THIRD EXAMPLE OF EMBODIMENT

### F Term Providing Operation

Next, will be described an embodiment in which an output file is outputted which is related to a theme code and the F term for a keyword in a sentence printed on the paper 2 in an F term providing operation used for patent classification in Japan.

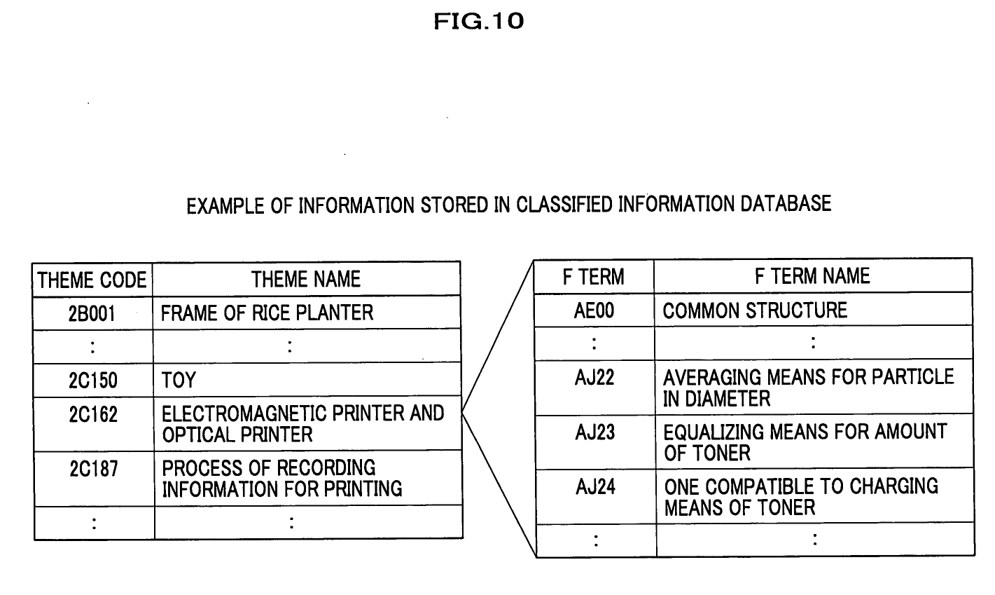

First, will be described in detail the information stored in the classified information database 312 of the pen server 3 shown in FIG. 1. Here, FIG. 10 is a drawing indicating the information stored in the classified information database 312. As shown in FIG. 10, the classified information database 312 stores table data, indicated with a symbol 79, where theme codes of the F terms and theme names corresponding to them are stored, the F terms corresponding to each record of the table data, indicated by the symbol 70, where the F term and a name corresponding thereto with making a hierarchy structure.

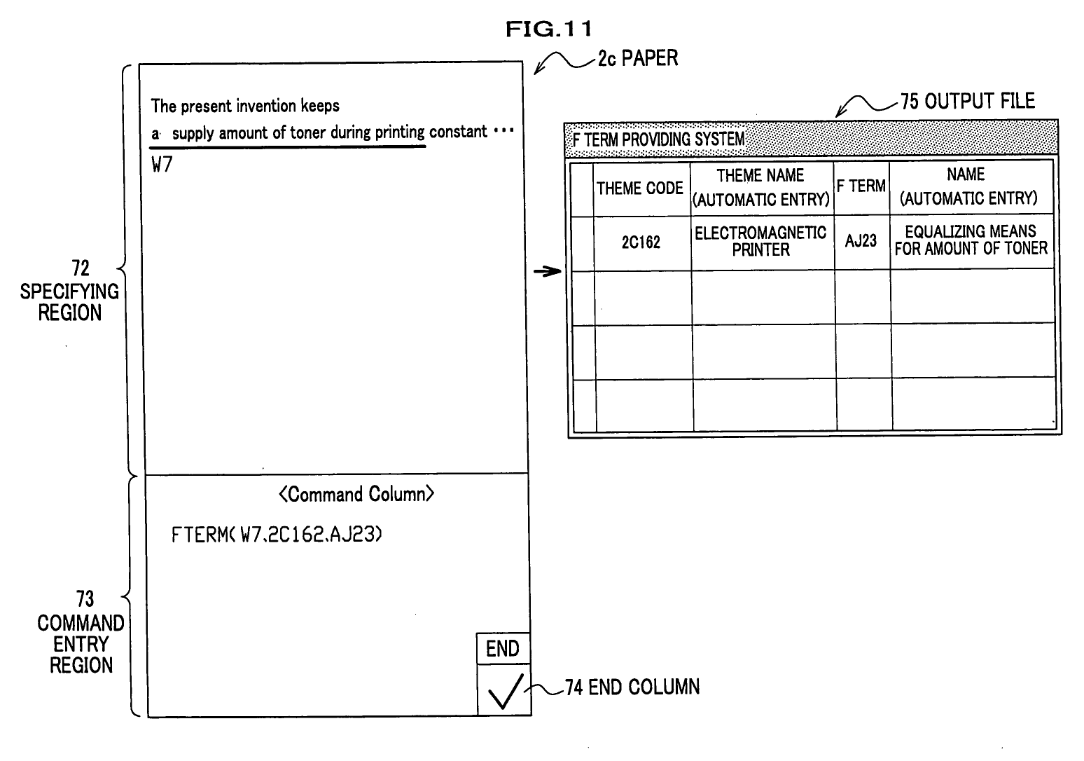

Next, FIG. 11 is a drawing showing an example of the paper 2c and an output file 75 of the third example of the embodiment. As shown in FIG. 11, the paper 2c of the third example of the embodiment is subject to print of the paper space information of, for example, a patent specification, and is configured with a specifying region 72 for specifying with the digital pen 1a keyword for providing relation and a command entry region 73 for entering the command for causing editing with the digital pen 1. Further, at a lower right portion of the command entry region 73 is included an end column 74 where the check is entered when the entry with the digital pen 1 is finished.

The person of the inscription, while viewing the paper space information printed on the specifying region 72, enters the symbol in its vicinity after, for example, underlining a keyword which is desired to be related to the theme code and the F term. In the example shown in FIG. 11, a keyword “an amount of supplying toner upon printing” is underlined and a symbol ‘W7’ is entered at its lower left portion.

In the command entry region 73, the commands for causing the pen server 3 to execute editing and its parameters are entered. In the example shown in FIG. 11, it is understood that the command ‘FTERM’ and its parameters ‘(W7, 2C162, AJ23)’ are entered. The command ‘FTERM’ means to “search for a theme name corresponding to the theme code ‘2C162’ and a name corresponding to the F term ‘AJ23’ and relates the keyword ‘W7’ with them to output them.” Thus, the pen server 3 recognizes this command and outputs an output file 75.

In addition, in the third example of the embodiment, the procedure in which the pen server 3 acquires the stroke data to recognize the command and the like entered on the paper 2c is similar to the procedure (steps S100 to S105), shown in FIG. 6, described in the first example of the embodiment, and thus the description will be omitted.

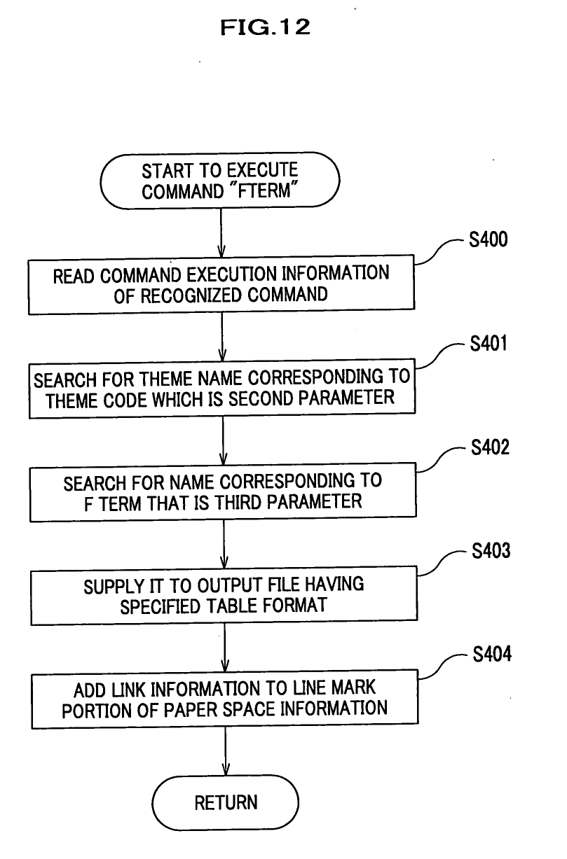

However, in the present embodiment, the commands entered in the command entry region 73 are different from those in the first embodiment, and thus the execution process of the commands in the step S107 will be described in detail. FIG. 12 is a flowchart describing the procedure of the command execution process when the command ‘FTERM’ is recognized in the procedure for judging whether the command in the step S106 is present or absent.

With reference to the flowchart shown in FIG. 12 will be described the command execution process when the command ‘FTERM (W7, 2C162, AJ23)’ is entered similarly to the command entry region 73 of the paper 2c shown in FIG. 11 (see FIGS. 1 and 11 as needed).

First in the step S106, if the command recognizing portion 306 of the pen server 3 recognizes the command ‘FTERM’, the command executing portion 307 of the pen server 3 reads the command execution information of the command ‘FTERM’ (step S400). After that, the command executing portion 307 searches with this command execution information the classified information database 312 for the theme name corresponding to the theme code ‘2C162’ which is a second parameter on the basis of the command ‘FTERM’ (W7, 2C162, AJ23) (step S401).

Next, the command executing portion 307 searches the classified information database 312 for a name corresponding to the F term ‘AJ23’ that is the third parameter (step S402). Further, it outputs a search result in the steps S401 and S402 as the output file 75 having a table format shown in FIG. 11 (step S403). In addition, the command executing portion 307 adds link information for a record corresponding to the output file 75 to the paper space information of the keyword “an amount of toner supplied upon printing” to which the first parameter ‘W7’ is attached and then stores it in the paper space information database 310 (step S404).

By the above-mentioned procedure, relating of the theme code and the F term corresponding to the keyword in the F term providing operation is executed by the pen server 3.

Here, the F term that is a patent classification in Japan is cited as an example. However, for example, in a case that IPC that is an internal patent classification is used, it can be similarly executed, for example, by replacing the theme code and the F term with a subclass title and a subgroup title and respectively corresponding theme name and name with subclass title and subgroup title.

### FOURTH EXAMPLE OF EMBODIMENT

### Addition of Paper Space Information

Next, will be described an example of the embodiment where an entry content is added with the digital pen 2 to the paper space information of the meeting material shown in the second example of the embodiment with the editing system of the embodiment mentioned above.

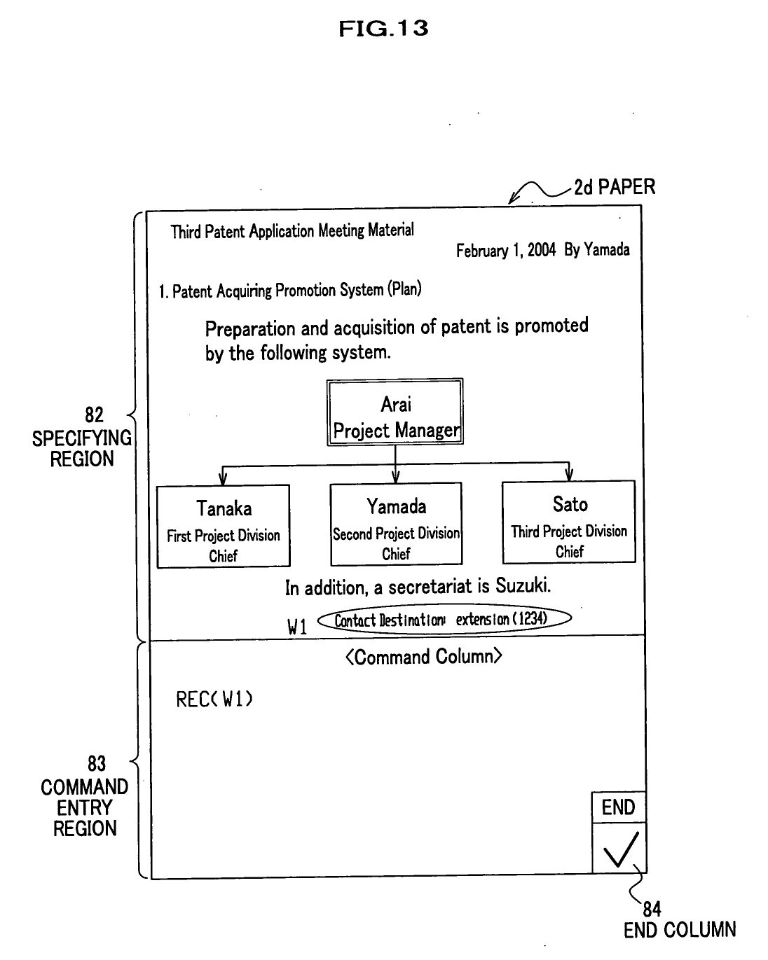

Here, FIG. 13 is a drawing showing an example of a paper 2d of the fourth example of the embodiment. As shown in FIG. 13, the paper 2d of the fourth example of the embodiment subject to printing the paper space information of a content similar to that of the second example of the embodiment and is configured with a specifying region 82 for specifying by entry with the digital pen 1a content that is desired to be added to the space information of the meeting material and a command entry region 83 that is a region in which commands for causing the pen server 3 to execute editing are entered with the digital pen 1. In addition, at the lower right portion of the command entry region 83 is included an end column 84 in which the check is entered when the entry with the digital pen 1 is finished.

Here, on the paper 2d, a circle in the specifying region 82, a description about ‘extension (1234)’ entered in the circle, and a symbol ‘W1’ entered in the circle are entered with the digital pen 1, and characters other than it are provided by printing the paper space information stored in the paper space information database 310. Further, ‘REC (W1)’ in the command entry region 63 is also entered with the digital pen 1.

The person of the inscription enters with the digital pen 1 at a desired location a content desired to be added to the meeting material while viewing the paper space information printed, and circles the entered content, and enters the symbol in the vicinity of it. In the example shown in FIG. 13, first, ‘contact destination extension (1234)’ is entered. The entered portion is circled, and at a lower left portion is entered a symbol ‘W1’.

Further, in the command entry region 83 are entered the command for causing the pen server 3 to execute editing and its parameter. In the example shown in FIG. 13, it is understood that the command ‘REC’ and its parameter ‘(W1)’ are entered. The command ‘REC (W1)’ means, as indicated at the command database 309 shown in FIG. 3, to recognize “the portion related to ‘W1’ and to add it to the paper space information.” The pen server 3 recognizes the command and changes the paper space information of the paper 2d stored in the paper space information database 310.

In addition, in the fourth example of the embodiment, the procedure in which the pen server 3 acquires the stroke data and recognizes the commands and the like entered on the paper 2d is similar to the procedure shown in FIG. 6 (from the step S100 to the step S105) described in the first example of the embodiment, and thus the detailed description will be omitted.

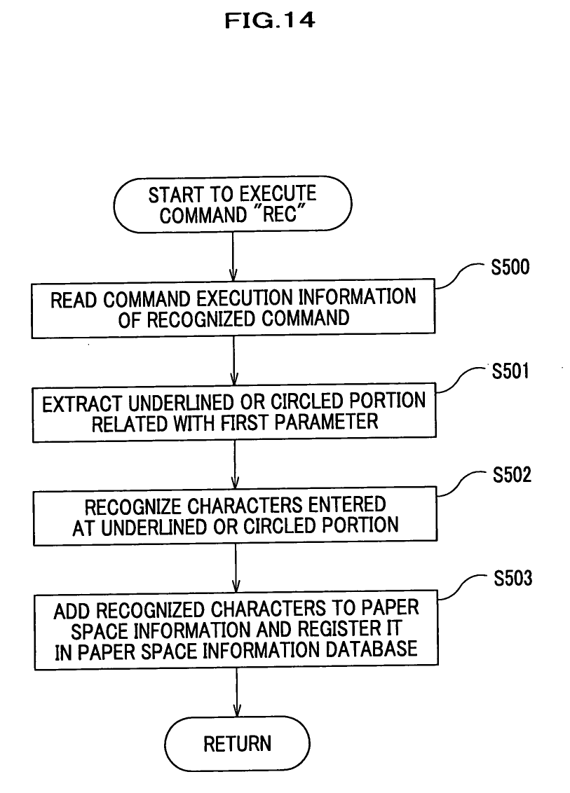

However, in the fourth example of the embodiment, the commands entered in the command entry region 83 are different from those in the first example of the embodiment, and thus the execution process of the commands in the step S107 will be described in detail. Here, FIG. 14 is a flowchart showing a procedure in which the pen server 3 recognizes the commands entered on the paper 2d and converts them into the paper space information of the paper 2d. With reference to the flowchart shown in FIG. 14, will be described a procedure of the command execution process by the pen server 3 where the command ‘REC (W1)’ is entered as shown in the command entry region 83 of the paper 2d shown in FIG. 13 (see FIGS. 1 and 13 as needed).

First, in the step S106, when the command recognizing portion 306 of the pen server 3 recognizes the commend ‘REC’, the command executing portion 307 of the pen server 3 reads command execution information of the command ‘REC’ from the command database 309 (see FIG. 3) (step S500). Next, the command executing portion 307 extracts the image data of the stroke data, at the circled portion, related to the symbol ‘W1’ that is the first parameter from the location information database 311 on the basis of the command execution information (step S501), recognizes characters from the extracted image data at the character recognizing portion 304, and converts them into character codes (step S502).

Next, the command executing portion 307 adds the character codes of the recognized characters to the paper space information of the paper 2d stored in the paper space information database 310 (step S503) for registration. At this event, the character codes to be added are added corresponding to the locations actually entered with the digital pen 1 on the paper 2d.

In addition, at this event, it is possible to rewrite the paper space attribution information of the region circled with the digital pen 1 out of the paper space attribution information of the paper 2d stored in the paper space information database 310 as a region where characters are to be entered.

By the above-mentioned procedure, the character information entered with the digital pen 1 is added to the paper space information of the paper 2d stored in the paper space information database 310.

As mentioned above, according to the editing system of the embodiment various complicated editing processes can be executed by the entry with the digital pen 1 without using input means for operating GUI such as a keyboard and a mouse.

In addition, in the present embodiment, the examples of four commands are described with four examples of the embodiment. However, editing processes other than those can be executed by adding command execution information to the command database 309.

Further, in the present embodiment, the examples where the paper space information stored in the paper space information database 310 are edited. However, it is possible to prepare new paper space information with the command ‘REC’ on the paper 2 made to have no correspondence with the paper space information to provide relationship with it. According to this, for example, storing, in the pen server 3, command execution information for causing adhesion of a figure entered with hand-writing and the figure data stored in another electronic data enables various editing processes even if the paper space information is newly prepared.

### INDUSTRIAL APPLICABILITY

According to the present invention, the complicated editing processes for the character information and the figure information conventionally executed with the keyboard and the mouse can be realized only by entry with the digital pen.

1. An editing system configured to include a paper which is prepared to specify an entry location and on which paper space information including a figure, a character, and the like is printed, a digital pen for acquiring information entered by handwriting as stroke data, and a pen server for executing an editing process of the paper space information on the basis of the stroke data acquired by the digital pen, the editing system characterized in that:
the pen server is configured to include:
a command database for inclusively storing command execution information for indicating a content of the editing process that the pen server is caused to execute to have correspondence to one or more command for specifying an editing process of the paper space information;
a paper space information database for storing the paper space information that corresponds to locations on the paper;
a character recognizing portion that recognizes a character from the stroke data and converts the recognized character into a character code;
a paper space information cutout portion that recognizes a line from the stroke data and extracts the paper space information included in a target region specified by the recognized line from the paper space information database;
a command recognizing portion that detects the command stored in the command database from the character code outputted by the character recognizing portion; and
a command executing portion that executes the editing process on the basis of the command execution information corresponding to the command detected by the command recognizing portion.

2. The editing system as claimed in claim 1 characterized in that the paper space information cutout portion recognizes the character or a mark, written in the vicinity of the target region and relates it as a symbol for identification to the extracted paper space information.

3. The editing system as claimed in claim 2 characterized in that in the command database are stored to have correspondence to a predetermined command:
parameter definition information for defining that a parameter added to the command is the symbol; and
command execution information for outputting as an electronic file the paper space information, extracted by the paper space information cutout portion, related to the parameter.

4. The editing system as claimed in claim 2 characterized in that in the command database is stored command execution information for converting, at the character recognizing portion, the stroke data entered on the paper with the digital pen into a character code outputted as an electronic file.

5. The editing system as claimed in claim 4 characterized in that in the command database is further stored correspondingly to a predetermined second command:
parameter definition information for defining that a parameter added to the second command is the symbol; and
command execution information for causing insertion of the paper space information, related with the parameter, extracted by the paper space information cutout portion, at an entry location of the second command of the electronic file on the assumption that it is entered after entry of the first command.

6. The editing system as claimed in claim 2 characterized in that the pen server is configured to further include a classified information database for storing a subclass title corresponding to a subclass used in International Patent Classification and a subgroup title corresponding to a subgroup,
in the command database are stored to have correspondence to a predetermined command:
parameter definition information for defining that a first parameter added to the command is the symbol, a second parameter is the subclass, and a third parameter is the subgroup; and
command execution information for searching the classified information database for the subclass title corresponding to the second parameter, and the subgroup title corresponding to the third parameter to output an electronic file, and adding link information directed to the electronic file to the paper space information related with the first parameter.

7. The editing system as claimed in claim 2 characterized in that in the command database are stored to have correspondence to a predetermined command:
parameter definition information for defining that the parameter added to the command is the symbol; and
command execution information for converting at the character recognizing portion the stroke data entered with the digital pen in the target region recognized by the paper space information cutout portion, related with the parameter, into a character code and adds it to the paper space information of the paper.

8. The editing system as claimed in any one of claim 1 or 7 characterized in that the paper on which the paper space information is printed is configured to include:
a specifying region for specifying a region for editing the paper space information with the digital pen; and
a command entry region for entering a command with the digital pen.

9. An editing method in an editing system configured to include a paper which is prepared to specify an entry location and on which paper space information including a figure, a character, and the like are printed, a digital pen for acquiring information entered by handwriting as stroke data, and a pen server for recognizing a command for causing an editing process of the paper space information from the stroke data acquired by the digital pen, the editing method characterized in that:
the pen server executes the editing process including:
a step of acquiring the stroke data entered on the paper;
a step of recognizing a line at a paper space information cutout portion of the pen server and judges the presence or absence of a target region specified by the recognized line;
a step of extracting at the paper space information cutout portion the paper space information contained in this region from the paper space information, corresponding to a location on the paper stored in the paper space information database, when the target region exists on the paper;
a step of recognizing a character from the stroke data to output a character code at a character recognizing portion of the pen server;
a step of relating a character or a mark entered in the vicinity of the target region as a symbol for identification to the extracted paper space information at the paper space information cutout portion;
a step of detecting at the command recognizing portion of the pen server the command stored in the command database from the character code outputted by the character recognizing portion with reference to a command database storing correspondingly to one or more command for identifying the editing process of the paper space information, command execution information for indicating a content of the editing process that causes the pen server to execute and parameter definition information for defining a parameter added to the command; and
a step of executing at the command executing portion of the pen server the editing process on the basis of the command execution information corresponding to the command detected at the command recognizing portion.

10. The editing method as claimed in claim 9 characterized in that the paper on which the paper space information is printed is configured to include:
a specifying region for specifying a region for editing the paper space information with the digital pen; and
a command entry region for entering a command with the digital pen.

11. A program for making a computer function as a pen server as claimed in any one of claims 1 to 7.
